(19) United States
(12) Patent Application Publication
(10) Pub. No.: US 2011/0099820 A1
(43) Pub. Date: May 5, 2011

(54) PENCIL SHARPENER

(75) Inventor: Ming-Tay HSU, Taoyuan Hsien (TW)

(73) Assignee: FOLUCK INTERNATIONAL CO., LTC

(21) Appl. No.: 12/938,425

(22) Filed: Nov. 3, 2010

(30) Foreign Application Priority Data
Nov. 5, 2009 (TW) 98220422

(51) Int. Cl. B43L 23/00

(52) U.S. Cl. 30/457

(57) ABSTRACT

A pencil sharpener includes a main body, a first gear, a second gear, a turning member, a top lid and an elastic piece. The first gear has a central hole for insertion of a pencil. The first gear engages with the second gear. The second gear has at least one waved portion thereon. The position of the turning member is changed by movement of the waved portion to open and close the top lid with respect to the main body, providing visual and sound effects. The elastic piece is located beside the first gear or the second gear. The elastic piece can sound along with rotation of the gears. The pencil sharpener of the present invention has visual and sound effects to attract consumers.

### BACKGROUND OF THE INVENTION

1. Field of the Invention

The present invention relates to a pencil sharpener, and more particularly to a pencil sharpener having visual and sound effects.

2. Description of the Prior Art

A conventional pencil sharpener has a single function to sharpen pencils. Manufacturers only change the shape or color of the pencil sharpeners to attract consumers. This is difficult to satisfy consumers for the demand of novelty.

Accordingly, the inventor of the present invention has devoted himself based on his many years of practical experiences to improve the aforesaid problems of the conventional pencil sharpener and to develop a pencil sharpener with sound and fun during operation.

### SUMMARY OF THE INVENTION

The primary object of the present invention is to provide a pencil sharpener, which has visual and sound effects. By turning a pencil to be sharpened in the pencil sharpener, a top lid on the pencil sharpener can be opened and closed to provide visual and sound effects and an elastic pieces in the pencil sharpener can sound, either. In this way, the pencil sharpener is fun during operation.

In order to achieve the aforesaid objects, the present invention comprises a main body and a top lid. A first gear, a second gear and a turning member are provided in the main body. The first gear has a central hole for insertion of a pencil. The first gear engages with the second gear. The second gear has at least one waved portion thereon. The position of the turning member is changed by movement of the waved portion to open and close the top lid with respect to the main body, providing visual and sound effects. An elastic piece is provided beside the first gear or the second gear. The elastic piece can sound along with rotation of the gears.

### BRIEF DESCRIPTION OF THE DRAWINGS

FIG. 1 is an exploded view of the present invention;

FIG. 2 is a perspective view of the present invention;

FIG. 3 is a schematic view of the present invention to show the inside configuration of the pencil sharpener when in use; and

FIG. 4 is a perspective view of the present invention when in use.

### DETAILED DESCRIPTION OF THE PREFERRED EMBODIMENTS

Embodiments of the present invention will now be described, by way of example only, with reference to the accompanying drawings.

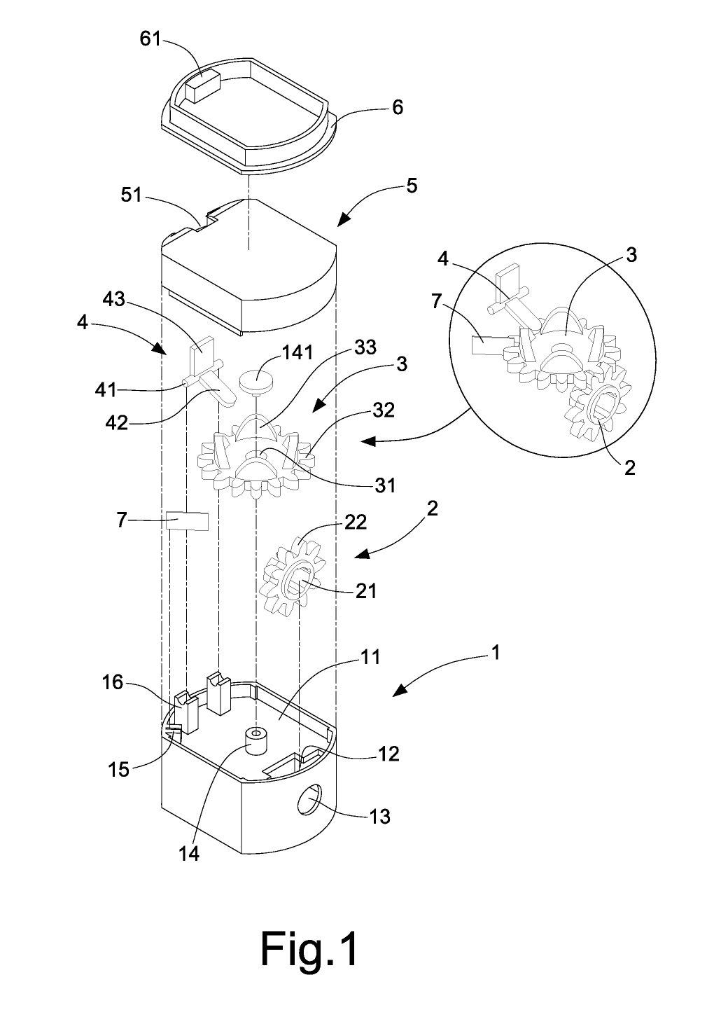

As shown in FIG. 1, the pencil sharpener of the present invention comprises a main body 1, a first gear 2, a second gear 3, a turning member 4, an upper cover 5, a top lid 6, and an elastic piece 7.

The main body 1 has a chamber 11, a trough 12 at one side of the chamber 11, and an opening 13 at one side of the main body 1. The trough 12 communicates with the opening 13. The opening 13 is provided with a blade (not shown in the drawings). The main body 1 further comprises an axle 14, a clamping portion 15 and a shaft seat 16 which are located in the chamber 11.

The first gear 2 is disposed in the opening 13. The first gear 2 has a central hole 21 which is coaxial with the opening 13. The first gear 2 has first teeth 22 formed around an outer wall thereof. The first gear 2 is disposed in the trough 12.

The second gear 3 has an axle hole 31 for insertion of the axle 14. An axle cap 141 is connected to the axle 14, such that the second gear 3 is positioned in the chamber 11. The second gear 3 has second teeth 32 formed around an outer wall thereof to engage with the first teeth 22 of the first gear 2. The second gear 3 has at least one waved portion 33 thereon. A recess is formed between every two adjacent waved portions 33.

The turning member 4 includes a transverse shaft 41 which is coupled to the shaft seat 16. An extension board 42 and a top board 43 are provided on the transverse shaft 41 at a specific angle. The extension board 42 has a distal end which is located on the second gear 3 and contact with the waved portion 33.

The upper cover 5 is coupled on the main body 1, and has a notch 51 for the top board 43 to extend out therefrom.

The top lid 6 is placed on the upper cover 5, and comprises a connecting portion 61 to connect with the top board 43.

The elastic piece 7 has one end connected to the clamping portion 15 and an opposing end which is located beside the second teeth 32 of the second gear 3.

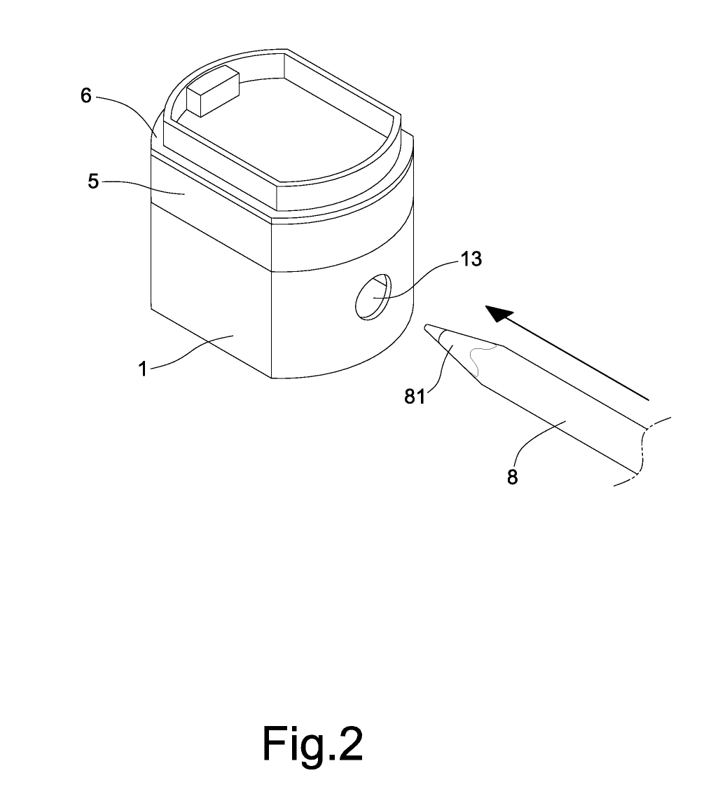

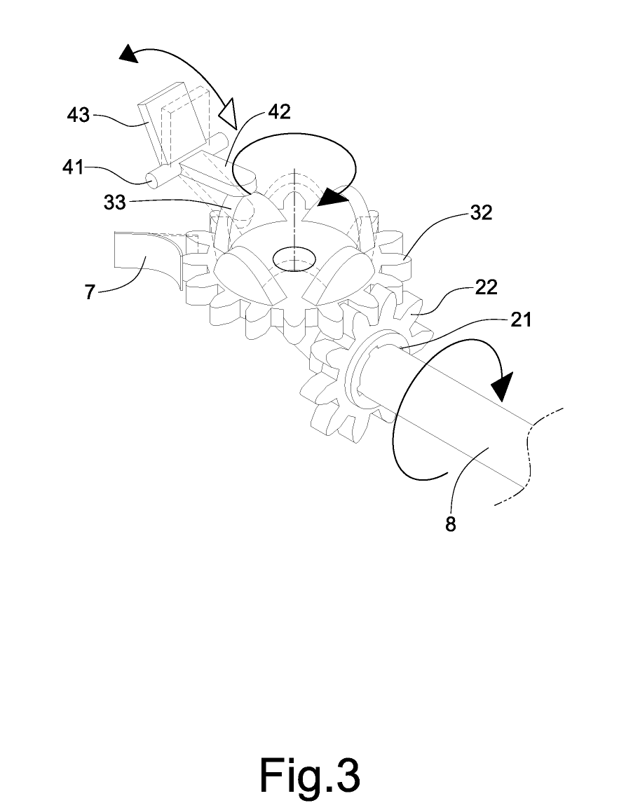

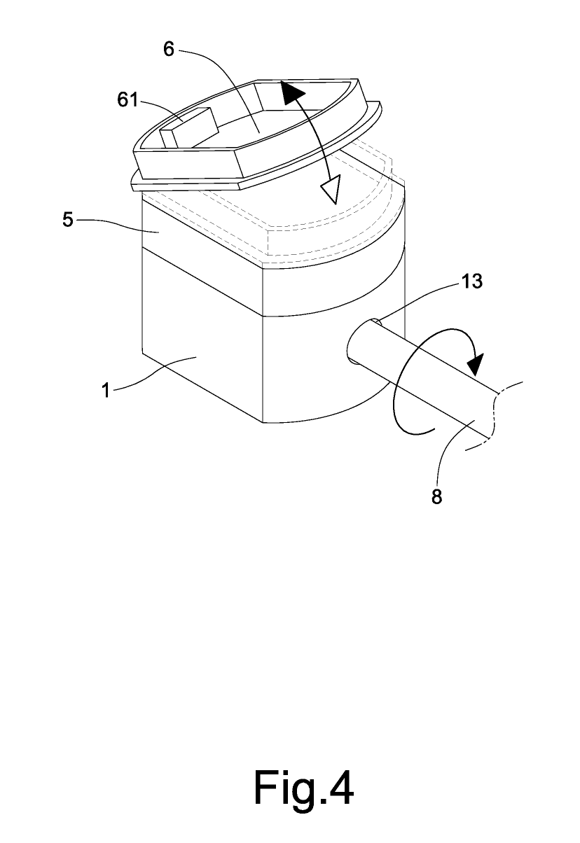

As shown in FIG. 2, when a writing end 81 of a pencil 8 is inserted in the opening 13, the pencil 8 will be engaged in the central hole 21 of the first gear 2. To sharpen the pencil 8, the pencil 8 is turned to bring the first gear 2. Because the first gear 2 engages with the second gear 3, the second gear 3 is driven to turn and the position of the waved portion 33 is changed. The extension board 42 will be moved up and down along with movement of the waved portion 33, as shown in FIG. 3, so that the turning member 4 and the top board 43 are also moved. When the extension board 42 is contact with the top of the waved portion 33, the top board 43 will be moved rearward to lift the top lid 6 to be an open state. On the contrary, when the extension board 42 is in the recess between two waved portions 33, the top board 43 will be moved forward to lower the top lid 6 to be a closed state with respect to the upper cover 5. As shown in FIG. 4, by turning the pencil 8, the top lid 6 is driven to move up and down, providing a fun effect.

The top lid 6 is driven to move up and down by turning the pencil 8, which also makes sounds when the top lid 6 collides with the upper cover 5. Besides, the distal end of the elastic piece 7 will be twanged by the second teeth 32 to sound when the second gear 3 is turned.

The elastic piece 7 may be located beside the first gear 2, so that the elastic piece 7 can sound along with rotation of the first gear 2.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A pencil sharpener, comprising:
a main body having an opening at one side thereof;
a first gear disposed in the main body, the first gear having a central hole which is coaxial with the opening of the main body, the first gear having first teeth formed around an outer wall thereof;
a second gear disposed in the main body, the second gear having second teeth formed around an outer wall thereof to engage with the first teeth of the first gear, the second gear further having at least one waved portion thereon;
a turning member disposed in the main body, the turning body including a transverse shaft, the transverse shaft being provided with an extension board and a top board at a specific angle, the extension board having a distal end which is located on the second gear and contact with the waved portion; and
a top lid placed on an upper cover, the top lid comprising a connecting portion to connect with the top board.

2. The pencil sharpener as claimed in claim 1, wherein the upper cover is coupled on the main body and has a notch for the top board to extend out therefrom.

3. The pencil sharpener as claimed in claim 1, wherein the main body has a chamber and a trough at one side of the chamber, the trough communicating with the opening, the opening being provided with a blade.

4. The pencil sharpener as claimed in claim 3, wherein the main body further comprises an axle and a shaft seat which are located in the chamber.

5. The pencil sharpener as claimed in claim 3, wherein the first gear is disposed in the trough.

6. The pencil sharpener as claimed in claim 4, wherein the second gear has an axle hole for insertion of the axle.

7. The pencil sharpener as claimed in claim 4, wherein transverse shaft is coupled to the shaft seat.

8. The pencil sharpener as claimed in claim 3, wherein the main body further comprises a clamping portion located in the chamber, an elastic piece having one end connected to the clamping portion and an opposing end which is located beside the second teeth of the second gear.

9. The pencil sharpener as claimed in claim 1, wherein an edge of the first gear is provided with an elastic piece, one end of the elastic piece being connected to the clamping portion.
